(19) United States
(12) Patent Application Publication
(10) Pub. No.: US 2020/0025700 A1
(43) Pub. Date: Jan. 23, 2020

(54) SINGLE-INPUT MULTIPLE OUTPUT NANOMATERIAL BASED GAS SENSOR

(71) Applicant: Universities Space Research Association, Mountain View, CA (US)

(72) Inventors: Jin-Woo Han, Mountain View, CA (US); Dong-II Moon, Mountain View, CA (US); Meyya Meyyappan, Mountain View, CA (US)

(21) Appl. No.: 16/277,132

(22) Filed: Feb. 15, 2019

Related U.S. Application Data
(60) Provisional application No. 62/631,032, filed on Feb. 15, 2018.

(51) Int. Cl. G01N 27/12; G01N 27/30

(52) U.S. Cl. CPC G01N 27/127; G01N 27/30; G01N 27/122

(57) ABSTRACT

A single input multiple output nanomaterial based gas sensor having multiple terminals situated on a single sensor device, providing a N(N−1)/2 measurements for a single device. Resistance is measured from any arbitrary pair of electrodes; repeating the measurements for all combinations of electrode pairs creates the data set. The gas sensor response is the ratio of resistance shift over the initial resistance (Rt−Ro)/Ro, where Rt and Ro are resistance upon gas exposure and initial resistance, respectively. The sensor response time is the time needed to reach a stable output signal when an external stimulus is introduced.

### STATEMENT OF GOVERNMENT RIGHTS

This invention was made with Government support under contract NNA16BD14C awarded by NASA under case ARC-18089-1. The Government has certain rights in this invention.

### BACKGROUND OF THE INVENTION

### Field of the Invention

The present invention relates to a nanomaterial based gas sensor and a method of operating the same, and more particularly to a nanomaterial based gas sensor that has high accuracy and less sensor-to-sensor variability.

### Description of the Background

Successful transition to commercialization of nanotechnology innovations may very well need device designs that are tolerant to the inherent variations in all nanomaterials including carbon nanotubes, graphene and others. As an example, a single walled carbon nanotube network-based gas sensor is promising for a wide range of applications such as environment, industry, biomedical and wearable devices due to its high sensitivity, fast response and low power consumption. However, a longstanding issue has been the production of extremely high purity semiconducting nanotubes, thereby contributing to the delay in the market adoption of the sensors. Inclusion of even less than 0.1% of metallic nanotubes, which is inevitable, is found to result in a significant deterioration of sensor-to-sensor uniformity.

Nanomaterials such as carbon nanotubes (CNTs), graphene, nanowires and nanoparticles have been successfully considered in a wide range of applications over the last two decades, but implementation of these advances in practical systems and commercialization have been rather slow. One major reason is the lack of consistency in device performance and device-to-device variations causing reliability and reproducibility issues and impeding commercialization. While material quality and processing issues—which may be solved in the long run—can lead to this problem, the inherent nature of some of the nanomaterials may very well make it unrealistic to solve the problems using conventional approaches. An example can be made with the current situation of most applications using single walled carbon nanotube (SWCNTs), which lack reliable and cost effective way to control the type (metallic vs. semiconducting) and chirality, either during growth or post-processing. Likewise, graphene lacks a reliable and cost effective way to control the number of layers precisely and uniformly and also to introduce a pre-specified bandgap in a controlled manner. Application development for these materials in sensors, electronics, photonics etc. to date has acknowledged the above deficiencies but largely relied on using device designs that have long been used for thin films of silicon and other established materials. Successful transition to commercialization may very well need device designs that are tolerant to the inherent variations in nanomaterials.

Carbon nanotube based gas sensors can be constructed with either individual semiconducting SWCNT or an ensemble of SWCNTs. Sensors with individual semiconducting SWCNT have been shown to yield greater response than the ensemble nanotube devices. The electrical response of the ensemble sensor is deteriorated by the inherent nature of semiconducting and metallic nanotube mixture in as-produced material as well as purified samples which are not sorted for nanotube type. Therefore, a certain degree of metallic nanotubes present in the network alters the response characteristics since the metallic portion is insensitive to charge transfer and other molecular interactions involved in gas sensing. In spite of the superiority of the individual nanotube based devices, most of the sensor studies reported in the literature have focused on using CNT networks due to ease of fabrication. Also, the ensemble-type sensors are considered to be closer to volume manufacturing in the absence of any breakthrough in individual nanotube process, purity/type control and alignment issues. In fact, ensemble CNT devices have been demonstrated for various applications including integrated circuit, energy storage, displays and sensors. Even in all these demonstrations, however, the device to device variability inevitably remains as a fundamental challenge for commercialization because of the statistical randomness of metallic vs. semiconducting fraction, network formation and nanotube density.

### SUMMARY OF THE INVENTION

Acknowledging the coexistence of metallic and semiconducting nanotubes and other possible imperfections, we herein present a novel variation-tolerant sensor design where the sensor response is defined by a statistical Gaussian measure in contrast to the traditional deterministic approach. The single input and multiple output data is attained using multiport electrodes fabricated over a single nanotube ensemble. The data processing protocol discards outlier data points and the origin of the outliers is investigated. Both the experimental demonstration and complementary analytical modeling support the hypothesis that the statistical analysis of the device can strengthen the reliability of the sensor constructed using nanomaterials with any imperfections. The proposed strategy can be applied to physical, radiation and biosensors as well as other electronic devices.

In order to tackle the foregoing variability issues, a variation-aware and variation-tolerant sensor design and data analysis strategies are presented in this invention. The fabricated sensor consists of a single sensing material surrounded by multiple electrodes, resulting in a combination of data set that can be post-processed to improve the sensor reliability. The critical information from outlier data points, if any, which represent failure in conventional two terminal sensor devices, is deliberately excluded from the data set. The origins of such outliers are also investigated. The sensors can be fabricated fully by inkjet printing, drop casting, or other vacuum process technology though the design would apply equally well to silicon and other substrates conventionally used in past nano chemsensor development.

Accordingly, there is provided according to the invention a variation-aware and variation-tolerant nano-material-based gas sensor having a single article of sensing nanomaterial, and a plurality of electrodes in electrical contact with the single article of sensing nanomaterial. There is further provided according to various embodiments of the invention a variation-aware and variation-tolerant nano-material-based gas sensor having three or four or more electrodes in electrical contact with the nanomaterial. There is further provided according to various embodiments of the invention a gas sensor having eight, twelve, sixteen or more electrodes in contact with the nanomaterial.

There is further provided according to various embodiments of the invention a gas sensor, wherein the electrodes are evenly spaced around a perimeter of said substrate.

There is further provided according to various embodiments of the invention a gas sensor, wherein the nanomaterial is selected from one or more of the following: carbon nanotubes, graphene, and nanowires

There is further provided according to various embodiments of the invention a gas sensor, wherein the nanomaterial is a network of single walled carbon nanotubes.

There is further provided according to various embodiments of the invention a gas sensor, wherein the nanomaterial includes a fraction of metallic nanotubes.

There is further provided according to various embodiments of the invention a gas sensor, further including a processor connected to the electrodes configured to receive an individual output signal from each of the electrodes.

There is further provided according to various embodiments of the invention, a gas sensor wherein the processor is configured to apply a statistical analysis to the individual output signals and generate a single composite output signal.

There is further provided according to various embodiments of the invention, a gas sensor wherein the processor is configured to identify outlying signals from among said individual output signals prior to generating said single composite output signal.

There is further provided according to various embodiments of the invention a method for sensing gas concentrations in an environment including the steps, exposing a variation-aware and variation-tolerant nano-material-based gas sensor to said environment, the gas sensor having a sensing nanomaterial, and a plurality of electrodes in electrical contact with the nanomaterial, using a computer processor to receive and save on a computer readable media an individual output signal from each of the electrodes; using a computer processor to automatically apply a statistical analysis to the individual output signals, generate a single composite output signal, and save the single composite output signal on the computer readable media.

### BRIEF DESCRIPTION OF THE DRAWINGS

The disclosure will be further described below by embodiments referring to accompanying drawings.

FIG. 1A is a representation of an array of two-terminal sensors according to the prior art.

FIG. 1B is a representation of a multi-terminal single sensor according to an embodiment of the present invention.

FIG. 2 is a chart showing variability of sensor response at fixed gas concentration from twenty different (A through T) two-terminal sensors.

FIG. 3 is a chart showing the Gaussian distribution of sub-sensor response in a multi-terminal single sensor device according to an embodiment of the invention.

### DETAILED DESCRIPTION

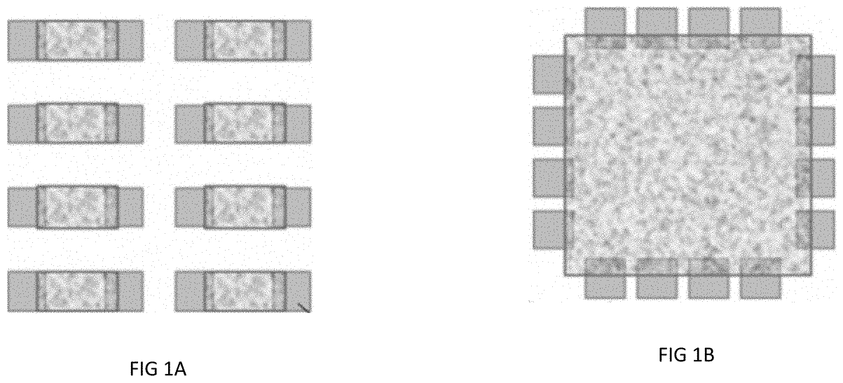

The presented multi-terminal single sensor is contrasted with the traditional two-terminal sensor array in FIGS. 1A and 1B. If N electrodes are placed, then N/2 individual devices and resultantly the same number of data set are produced in the array of two terminal sensors as shown in FIG. 1A. With the single film and multiple electrode device as illustrated in FIG. 1B, a total number of independent measurement set of N(N−1)/2 is possible. For example, a sixteen electrode system results in eight data points from the array of eight two-terminal devices while 120 measurement points are imported in one multiport sensor. As the number of electrodes N increases, the data size of the traditional two-terminal sensor array increases proportional to N while that of the multi-terminal single sensor increases proportional to N². Therefore, the multiport sensor produces a great deal of data points for a given footprint. In the multiport sensor, a resistance is measured from any arbitrary pair of electrodes, and repeating the measurements for all possible combinations of electrode pairs creates the data set. The resistance of the nanomaterial can increase or decrease depending on the type of target gas. The gas sensor response is defined as the ratio of resistance shift over the initial resistance (Rt−Ro)/Ro, where Rt and Ro are resistance upon gas exposure and initial resistance, respectively. The sensor response time is the time needed to reach a stable output signal when an external stimulus is introduced. Typically, 95% of the final value is used to estimate the response time, assuming the stimulus is a step change.

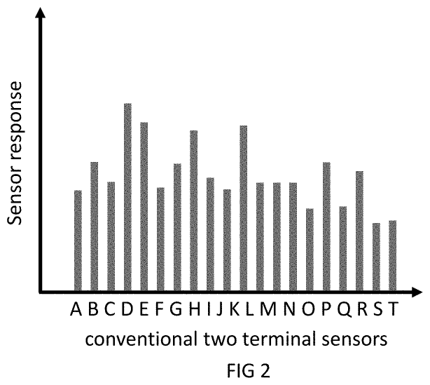

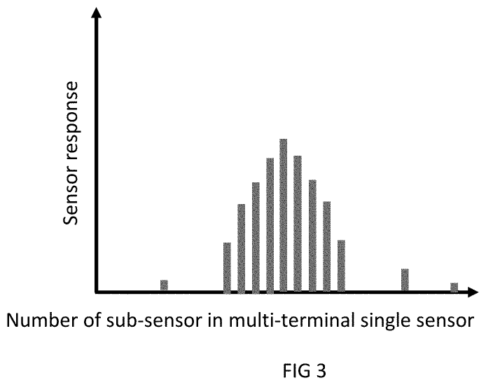

The variation in individual nanomaterial can cause the device to device variability. FIG. 2 show example of sensor response at fixed gas concentration from the same number of independent devices. As expected, a random distribution of baseline resistance is seen. FIG. 3 shows the distribution of sub-sensors in multi-terminal single sensor shown in FIG. 1B. The sensor response distribution shows a Gaussian distribution with some outliers.

The concept of variation-aware and tolerant design follows a single input and multiple output (SIMO) scheme, where the single input and multiple output refer to a single gas concentration and the collection of multiple terminal responses, respectively. In the case of the conventional two-terminal chemiresistor, the electrical characteristics are determined by the probe material between the two electrodes, where only one output signal can be collected for the corresponding sensing event. So, the device-to-device variation is directly reflected on the final output response. Multiple sensors constructed in an array may enhance the response credibility by averaging the data from all the sensors in the array shown in FIG. 1A. The SIMO design can produce multiple output data points from the single sensing material as seen in FIG. 1B. All data points in FIG. 3 showed change in resistance upon exposure to a target gas. So, the sensing material is qualitatively functional. However, the response values of each observation are distributed over different percentages instead of a single value, and the spread could be worse, depending on several material/process quality factors. This spread is discouraging for the nanotube-based sensors, requiring further calibration. For that matter, any nanomaterial-based sensor is expected to behave similarly and require calibration schemes.

Therefore, instead of the deterministic single reading in the traditional gas sensor, a statistical reading is used in the present variation-tolerant approach. The distribution of sub-sensors shows normal distribution, and the simple average of all responses can represent the SIMO response. In principle, the average of the samples of observations converges into nearly normal distribution only when the number of observations is sufficiently large. In another embodiment, the sensor response is obtained by fitted into a Gaussian distribution using a least square parameter method.

In another embodiment, such average or Gaussian fitting can be done after removing outlier point. The aforementioned methods are based on random errors. There is, in principle, always a possibility of systematic error generating outlier points. Such outliers, normally considered as bad data, may be purposely excluded as long as the detection of erroneous data is credible. Two possible categories of outliers can be considered. The first one is structural outlier wherein the device itself is structurally defective so that the initial resistance deviates from the intrinsic resistance distribution. Another is a functional outlier wherein the device shows normal distribution but the gas response deviates a lot from the response distribution. As the sensor uses the baseline data as its reference, the impact of initial resistance is important. A simple outlier test method is the Z-score method, Z=(Yᵢ−Yₘ)/s, where Yᵢ, Yₘ, and s are the sample value, mean and standard deviation, respectively. Other outlier test methods can be considered as well, for example, extreme studentized deviate (ESD) can be a good alternative. After excluding the outliers from the initial device, functional outlier checking can be carried out on the fly. In some cases, a simple Z-score test used to detect structural outliers from one-dimensional histogram graph may be incomplete. Om another embodiment, in order to systematically detect the multivariate outlier, Mahalanobis Distance (MD), a distance of a data point from the calculated centroid, can be useful. The MD score accounts for the covariances between variables and takes into consideration that the variances in each variable are different. The squared MD score is MD²=(X−μ)^{T}Σ(X−μ), where X and μ are the two dimensional vector of observation and mean, respectively and Σ is the covariance matrix.

Despite these outliers showing far greater or lowest response, including them in the post measurement data processing may cause overestimation or underestimation of the sensor performance. Accordingly, the erroneous data should be discarded.

1. A variation-aware and variation-tolerant nano-material-based gas sensor comprising a sensing nanomaterial, and a plurality of electrodes in electrical contact with said nanomaterial.

2. A variation-aware and variation-tolerant nano-material-based gas sensor according to claim 1 comprising three or more electrodes in electrical contact with said nanomaterial.

3. A variation-aware and variation-tolerant nano-material-based gas sensor according to claim 1 comprising four or more electrodes in electrical contact with said nanomaterial.

4. A variation-aware and variation-tolerant nano-material-based gas sensor according to claim 1 comprising eight or more electrodes in electrical contact with said nanomaterial.

5. A variation-aware and variation-tolerant nano-material-based gas sensor according to claim 1 comprising twelve or more electrodes in electrical contact with said nanomaterial.

6. A variation-aware and variation-tolerant nano-material-based gas sensor according to claim 1 comprising sixteen or more electrodes in electrical contact with said nanomaterial.

7. A variation-aware and variation-tolerant nano-material-based gas sensor according to claim 1, wherein said electrodes are evenly spaced around a perimeter of said substrate.

8. A variation-aware and variation-tolerant nano-material-based gas sensor according to claim 1, wherein the nanomaterial is selected from one or more of the following: carbon nanotubes, graphene, and nanowires

9. A variation-aware and variation-tolerant nano-material-based gas sensor according to claim 1, wherein the nanomaterial is a network of single walled carbon nanotubes.

10. A variation-aware and variation-tolerant nano-material-based gas sensor according to claim 1, wherein the nanomaterial comprises a fraction of metallic nanotubes.

11. A variation-aware and variation-tolerant nano-material-based gas sensor according to claim 1, further comprising a processor connected to said electrodes configured to receive an individual output signal from each of said electrodes.

12. A variation-aware and variation-tolerant nano-material-based gas sensor according to claim 11 wherein said processor is configured to apply a statistical analysis to said individual output signals and generate a single composite output signal.

13. A variation-aware and variation-tolerant nano-material-based gas sensor according to claim 12 wherein said processor is configured to identify outlying signals from among said individual output signals prior to generating said single composite output signal.

14. A method for sensing gas concentrations in an environment comprising, exposing a variation-aware and variation-tolerant nano-material-based gas sensor to said environment, said gas sensor comprising a sensing nanomaterial, and a plurality of electrodes in electrical contact with said nanomaterial, using a computer processor to receive and save on a computer readable media an individual output signal from each of said electrodes; using a computer processor to automatically apply a statistical analysis to said individual output signals, generate a single composite output signal, and save said single composite output signal on said computer readable media.
